(19) United States
(12) Patent Application Publication
(10) Pub. No.: US 2013/0098724 A1
(43) Pub. Date: Apr. 25, 2013

(54) MODULAR ELECTRIC-VEHICLE ELECTRICITY SUPPLY DEVICE AND ELECTRICAL WIRE ARRANGEMENT METHOD

(71) Applicants: Nam Pyo Suh, Daejeon (KR); Dong Ho Cho, Seoul (KR); Chun Taek Rim, Daejeon (KR); Jong Woo Kim, Daejeon (KR); Kyung Min Park, Daejeon (KR); Bo Yune Song, Seoul (KR); Young Dong Son, Daejeon (KR); Joo Young Choi, Daejeon (KR); Byung O. Kong, Busan (KR); Sung Jun Son, Jeoniu (KR); Ji Chul Jang, Daejeon (KR); Chae Hun Lim, Daejeon (KR)

(72) Inventors: Nam Pyo Suh, Daejeon (KR); Dong Ho Cho, Seoul (KR); Chun Taek Rim, Daejeon (KR); Jong Woo Kim, Daejeon (KR); Kyung Min Park, Daejeon (KR); Bo Yune Song, Seoul (KR); Young Dong Son, Daejeon (KR); Joo Young Choi, Daejeon (KR); Byung O. Kong, Busan (KR); Sung Jun Son, Jeoniu (KR); Ji Chul Jang, Daejeon (KR); Chae Hun Lim, Daejeon (KR)

(21) Appl. No.: 13/510,218

(22) PCT Filed: Dec. 16, 2010
(86) PCT No.: PCT/KR2010/009019

§ 371 Date: Dec. 21, 2012

(30) Foreign Application Priority Data
Dec. 16, 2009 (KR) 10-2009-0125379
Dec. 24, 2009 (KR) 10-2009-0130493

(51) Int. Cl. B60L 11/18

(52) U.S. Cl. CPC B60L 11/182
USPC 191/10

(57) ABSTRACT

The present invention relates to a modular electric-vehicle electricity supply device and an electrical wire arrangement method, and more particularly, to an electric-vehicle electricity supply device and electrical wire arrangement method which use a modular approach such that respective modules can be controlled so as to be either ON or OFF; in which a plurality of a magnets disposed at right angles to the direction of travel on a road area provided spaced at predetermined intervals in the direction of travel on the road, and which comprises electricity supply cores formed such that the widths at right angles to the direction of travel on the road are very narrow, and comprises electricity supply wires arranged such that the magnets of electricity supply cores which neighbor each other in the direction of travel on the road have different polarities.

### TECHNICAL FIELD

The invention relates to a modular electric-vehicle electricity supply device and an electrical wire arrangement method, and more particularly, to an electric-vehicle electricity supply device and electrical wire arrangement method which use a modular approach such that respective modules can be controlled so as to be either ON or OFF; in which a plurality of a magnets disposed at right angles to the direction of travel on a road area provided spaced at predetermined intervals in the direction of travel on the road, and which comprises electricity supply cores formed such that the widths at right angles to the direction of travel on the road are very narrow, and comprises electricity supply wires arranged such that the magnets of electricity supply cores which neighbor each other in the direction of travel on the road have different polarities.

### BACKGROUND ART

FIG. 1 is a view illustrating a super thin electricity supply/collecting device which can have decreased magneto resistance despite of increased clearance. Illustrated are front view 110 and plan view 120 of a mono-rail system having one electricity supply wire 112, and front view 130 and plan view 140 of a dual-rail system having two electricity supply wires 131, 132. In June and August, 2009, Korea Advanced Institute of Science and Technology (KAIST) attached these to electric bus and sport utility vehicle (SUV) for traveling on average roads to achieve more than 70% system electricity efficiency rate despite of clearance which exceeded 16 cm. The clearance was as wide as 20 cm including the depth of the location the electricity supply device was buried under the road, and also considering the range of 20-40 cm of left/right allowable width deviation of the device, it was evaluated that the commercialization of the device is possible.

The problem with the above-explained approach lies in the fact that the width of the electricity supply rail has to be at least two times greater than a desired clearance. If the width of the electricity supply rail falls below 30 cm, magnetic field 114 coming out of one magnetic pole of the electricity supply apparatus 111 easily goes to the opposite magnetic pole directly, instead of going to the opposite magnetic pole by way of the electricity supply apparatus 113, thus causing deteriorated electricity supply. This means that the width of the electricity supply rail has to be approximately 50 cm width, if 25 cm of clearance is desired. That is, in case of mono rail 110, 120, the electricity supply device has 50 cm of width, which is same as the width of the electricity supply rail. However, in case of dual rail 130, 140, the electricity supply device has 100 cm of width, which is two times greater than that of the electricity supply rail. If the width of the electricity supply device increases, material cost for core and construction cost for road also increase. Besides, the level of electromagnetic field (EMF) along the side direction of the vehicle increases, hardly meeting the allowable reference range (i.e., less than 62.5 mG at 20 kHz).

Another problem of the above-mentioned approach lies in the requirement that the width of the electricity-collecting device increase as the clearance increases. The width of the electricity-collecting device has to increase in lateral direction to exceed the width of the electricity supply device as much as the degree of clearance, and also has to increase as much as the degree of allowable left/right steering deviation. For example, if clearance is 25 cm and the steering deviation is 30 cm, the width of the dual-rail electricity-collecting device has to be: 25 cm (clearance)×2 times×2(dual)+25 cm (clearance)×2 (left/right)+30 cm (steering deviation)×2 (left/right)=210 cm. This amounts to the length of an average bus, which does not meet the standards of a passenger car.

### DISCLOSURE

### Technical Problem

The present invention has been made to solve the problems discussed above, and an object of the invention is to keep increased clearance between the surface of road and electricity-collecting device, allow sufficient allowable width of steering deviation, which is generated in a lateral direction to the direction of travel of a vehicle, significantly reduce the width of electricity supply rail by designing I shape electricity supply core, to thereby greatly reduce cost and time for installing roads and also greatly reduce electromagnetic field (EMF) generated along the side of the road.

Another object is to reduce unnecessary electricity use and minimize influence of EMF by modularizing electricity supply rail and keeping respective unit rail modules in ON/OFF states, reduce cost for fiber reinforced plastic (FRP) tubes to protect the electricity supply rail by winding cables to a shape close to that of cores, and increase output by winding the electricity supply wires on respective core magnetic poles at least two times.

### Technical Solution

In order to accomplish the above-mentioned object, the present invention provides a modular electric-vehicle electricity supply device for supplying electricity to an electric vehicle in an inductive coupling manner, which includes an electricity supply core comprising a plurality of electricity supply core modules connected to each other along a direction of travel on a road, the electricity supply core modules each comprising one or more magnetic pole and an electricity supply wire coupling portion on both front and rear ends; an electricity supply wire arranged so that magnetic poles of the electricity supply core neighboring each other have different polarities along the direction of travel; and a common line to individually control the electricity supply core modules to be either ON or OF.

The electricity supply wire may be arranged such that the electricity supply wire is wound around each magnetic pole by at least two times.

Width of the electricity supply core at right angles to the direction of travel on the road may be at most a half of a magnetic pole gap which is a distance between centers of the magnetic poles.

The respective electricity supply core modules may be connected to each other as the electricity supply wires protruding from both ends of each of the electricity supply core modules is connected to each other are coupled by the electricity supply wire coupling portion.

Length of the magnetic pole in the direction of travel on the road may be at least two times greater than a distance between adjacent ends of the magnetic poles which neighbor each other.

The electricity supply core may be constructed so that the electricity supply core is faced straightforward or bent in lateral or vertical direction according to adjusting of coupling angle between the respective electricity supply core modules.

The electricity supply core and the electricity supply wire may be received inside a fiber reinforced plastic (FRP) tube to be protected from road environment.

The respective electricity supply core modules may be controlled to be in ON electricity supply state using the common line only when the electric vehicle passes thereabove.

According to another aspect of the invention, an electricity supply wire arrangement method (‘first method’) for winding electricity supply wires around respective electricity supply core magnetic poles of electricity supply modules of a modular electricity supply device which supplies electricity to an electric vehicle in an inductive coupling manner, the electricity supply wire arrangement method winding the electricity supply wires around the respective electricity supply core magnetic poles by an odd number of times, may include (a) arranging an electricity supply wire (‘first electricity supply wire’) from a left upper side of the electricity supply module to the right side in zigzag pattern between the respective electricity supply core magnetic poles; (b) winding the first electricity supply wire around a right side of a right-most magnetic pole of the electricity supply module, and extending the first electricity supply wire to the left side of the electricity supply module, in zigzag pattern in which the first electricity supply wire crosses the electricity supply wire arranged at step (a) between the respective electricity supply core magnetic poles; (c) winding the first electricity supply wire on a left side of a left-most magnetic pole of the electricity supply module, arranging the first electricity supply wire in zigzag pattern to the right side of the electricity supply module and arranging so that the first electricity supply wire exits to the right side of the electricity supply module; and (d) arranging another electricity supply wire (‘second electricity supply wire’) other than the first electricity supply wire in the same manners as in steps (a) to (c) between left lower side and the right side.

The first method may additionally include, between the steps (b) and (c), (b1) repeating the steps (a) to (b) by an integer number of times.

According to yet another aspect of the present invention, an electricity supply wire arrangement method (‘second method’) for winding electricity supply wires around respective electricity supply core magnetic poles of electricity supply modules of a modular electricity supply device which supplies electricity to an electric vehicle in an inductive coupling manner, the electricity supply wire arrangement method winding the electricity supply wires around the respective electricity supply core magnetic poles by an even number of times, may include (a) arranging an electricity supply wire (‘first electricity supply wire’) from a left upper side of the electricity supply module to a right side of a (n/2)th magnetic pole (‘intermediate magnetic pole’) out of (n) number of magnetic poles, in zigzag pattern between the respective electricity supply core magnetic poles; (b) winding the first electricity supply wire around a right side of the intermediate magnetic pole of the electricity supply module, and extending the intermediate electricity supply wire to the left side of the electricity supply module, in zigzag pattern in which the first electricity supply wire crosses the electricity supply wire arranged at step (a) between the respective electricity supply core magnetic poles; (c) winding the first electricity supply wire on a left side of a left-most magnetic pole of the electricity supply module, arranging the first electricity supply wire in zigzag pattern to the right side of the electricity supply module and arranging so that the first electricity supply wire exits to the right side of the electricity supply module; and (d) arranging another electricity supply wire (‘second electricity supply wire’) other than the first electricity supply wire in the same manners as in steps (a) to (c) between right upper side and the left side.

The second method may additionally include, between the steps (b) and (c), (b1) repeating the steps (a) to (b) by an even number of times.

According to the first and second methods, two or more electricity supply wires arranged in zigzag pattern between the respective electricity supply core magnetic poles may be arranged to cross each other in vertical direction.

### Advantageous Effects

According to the present invention, by forming electricity supply core in I shape, the width of the electricity supply rail is greatly reduced, the cost and time for installing roads and also the electromagnetic field (EMF) observed along the side of the road are greatly reduced, while large clearance is kept between the surface of the road and the electricity-collecting device and also sufficient allowable width of steering deviation, which is left/right inclination in the direction of travel of the vehicle, is given.

Further, unnecessary electricity use is reduced and influence by the electromagnetic field (EMF) is minimized by modularizing the electricity supply rail and keeping respective unit rail modules either in ON or OFF state, and cost for fiber reinforced plastic (FRP) tubes to protect the electricity supply rail from the road environment is reduced as the cable is wound to a shape close to that of the core, and also high output is obtained as the electricity supply wires are wound on the respective core magnetic poles at least two times.

### BRIEF DESCRIPTION OF DRAWINGS

FIG. 1 is a view illustrating a super-thin electricity supply/collecting device having reduced magneto resistance despite of increased clearance;

FIG. 2 is a plan view of an electricity supply rail at which an electric-vehicle electricity supply device is installed thereon in a structure in which an electric-vehicle electricity supply wire is wound around an I shape electricity supply core in a zigzag pattern;

FIG. 3 is a side view of an electricity supply rail at which an electric-vehicle electricity supply device is installed in a structure in which an electric-vehicle electricity supply wire is wound around an I shape electricity supply core in a zigzag pattern;

FIG. 4 is a front view of the electricity supply rail of FIG. 2 at which an electric-vehicle electricity supply device having a common line is installed, in a structure in which an electric-vehicle electricity supply wire is wound around an I shape electricity supply core in a zigzag pattern;

FIG. 5 is a front view of covers on both ends of an electricity supply rail module;

FIG. 6 is a front view illustrating a coupling state between the electricity supply core modules of an electric-vehicle I shape electricity supply device;

FIG. 7 is a side view illustrating a coupling state between the electricity supply core modules of an electric-vehicle I shape electricity supply device;

FIG. 8 is a plan view illustrating a coupling state between the electricity supply core modules of an electric-vehicle I shape electricity supply device and interior thereof;

FIG. 9 is a view illustrating an electricity supply module structure in which electricity supply wire is wound three times according to an embodiment;

FIG. 10 is a view illustrating an electricity supply module structure in which electricity supply wire is wound two times according to an embodiment; and

FIG. 11 is a view illustrating a method for winding an electricity supply wire using dual cable.

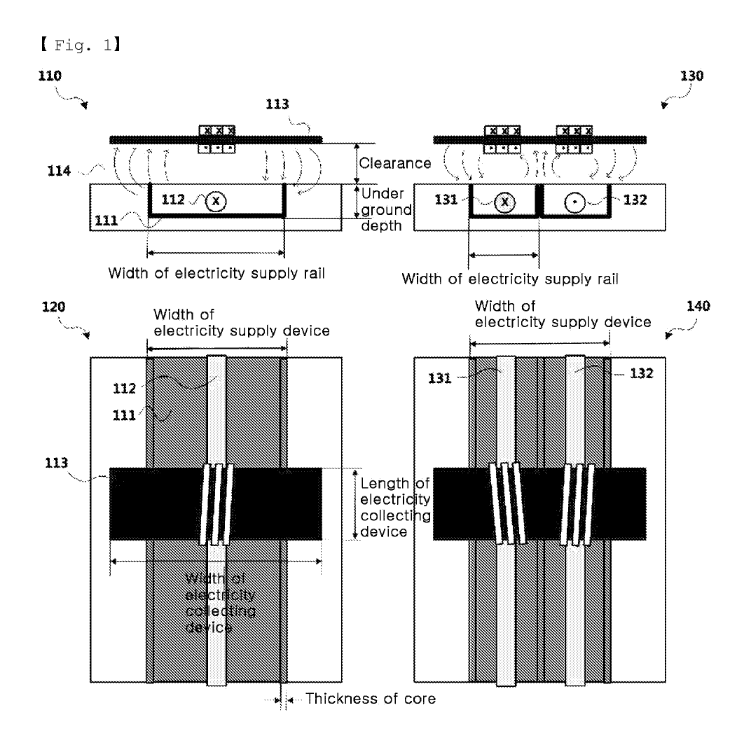

### BEST MODE

The present invention will be explained in greater detail below with reference to exemplary embodiments. The words or terms used throughout the description and the claims should not be interpreted based on the limited common understanding or definitions by the dictionaries, and it should be understood that the inventors can adequately define concepts of the terms to explain their invention in best way they can employ and that the words and terms should be interpreted as meanings and concepts that suit to the technical idea of the present invention. Accordingly, while the embodiments of the description or the structures illustrated in the drawings are mere desirable examples of the invention, these cannot represent the entire technical ideas of the invention. Therefore, it should be noted that there can be a variety of equivalents and modifications that can replace the embodiments of the invention at the time of filing.

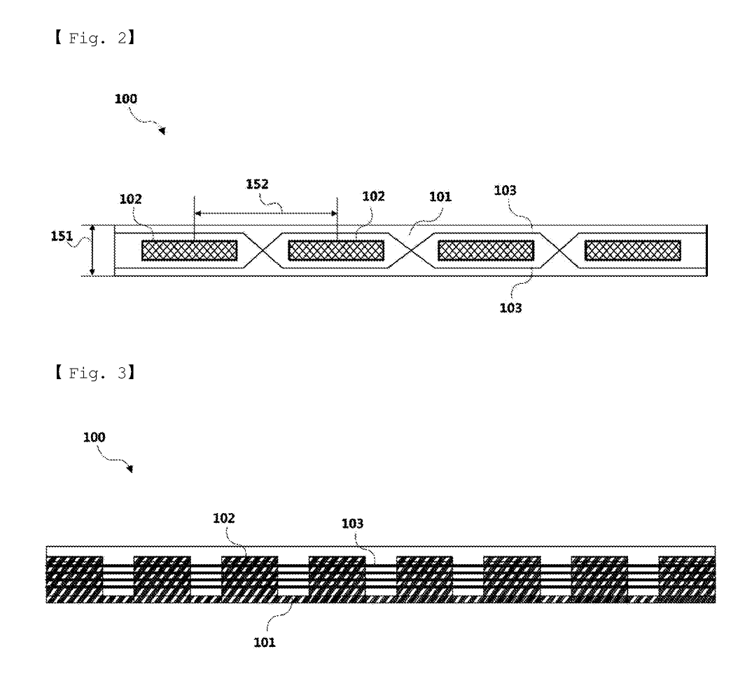

FIG. 2 is a plan view of an electricity supply rail at which an electric-vehicle electricity supply device 100 is installed, in which an electric-vehicle electricity supply wire is wound around an I shape electricity supply core in a zigzag pattern.

FIG. 2 illustrates an embodiment 100 of an I shape slim type electricity supply device, which has width 151 greatly reduced to below a half of a magnetic pole gap 152. The ‘magnetic pole gap 152’ herein refers to a distance between centers of the magnetic poles 102, and as shown in FIG. 2 and also will be understood in the same way throughout all the accompanying drawings, the ‘width 151’ of the electricity supply rail herein refers to the length of the electricity supply core 101 including electricity supply wire at right angles to the direction of travel on the road.

The magnetic poles 102 are part of the electricity supply cores 101, trough which magnetic field enters or exits, and hereinbelow, the term ‘electricity supply core’ refers to an integrated structure of the electricity supply core 101 and the magnetic pole 102.

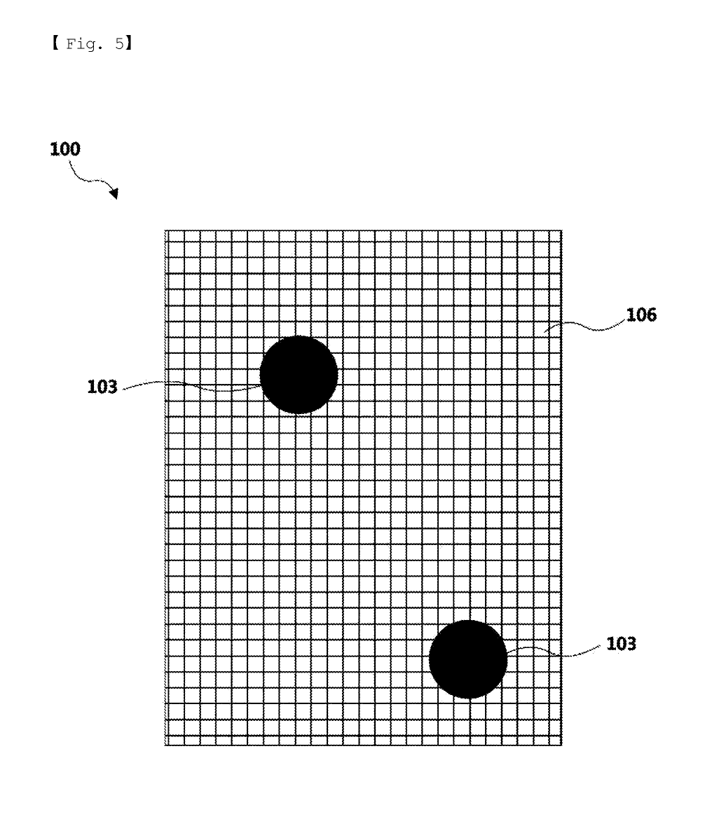

The reason for using the term ‘I shape’ herein is based on the I-shaped cross section of the electricity supply core 101, as is clearly shown in the front view of FIG. 4 (although not shown in FIG. 2) showing the I shape cross section of the electricity supply core 101 cut along at right angles to the direction of travel on the road.

Electricity supply wires 103 are provided above the electricity supply cores so that N and S magnetic lines of force are generated on the respective magnetic poles 102 alternately. If one electricity supply wire 103 is provided, this is mono-rail system. If two electricity supply wires 103 are provided, this is dual-rail system. In dual-rail system, electric currents in opposite directions flow the two electricity supply wires. FIG. 2 illustrates a dual-rail system according to an embodiment in which two electricity supply wires 103 are installed. In this system, the width 151 of the electricity supply rail can be reduced to below 10 cm, without causing any problem in keeping clearance, i.e., in keeping a distance between the top end of the magnetic pole 102 of the electricity supply device buried under the road and the electricity-collecting device installed on the lower portion of the vehicle above 20 cm. When viewed from the side, the direction in which the electricity supply wires are installed almost matches the direction of travel on the road. That is, the electricity supply wires and the electricity supply cores are buried almost in the same direction along the direction of travel on the road. Although the width 151 of the electricity supply rail decreases, the electricity transfer is not decreased in proportion to the width of the electricity supply rail. If the electricity reduction is less than the area reduction of the electricity supply rail, better cost and effect can be obtained.

FIG. 2 particularly illustrates an example in which the magnetic poles 102 are elongated in the direction of travel on the road to widen the area of the magnetic poles 102 of the I shape electricity supply device. That is, as the magnetic flux coming out of the electricity supply device 100 is converged due to the wide width of the electricity collecting module which is two or more times greater than the clearance, the magnetic circuit resistance decreases. This means that efficient electricity transfer can be achieved even when the width 151 of the electricity supply rail is narrow, if the length of the magnetic poles is increased in the direction of travel on the road. The term ‘electricity collecting module’ herein refers to the electricity-collecting cores including the electricity-collecting lines and electronic devices thereof.

As necessary, the width of the electricity supply rail may be further increased by approximately 10 to 20 cm to thus further increase electricity transfer efficiency. However, as mentioned above, increasing the width of the electricity supply rail does not greatly increase the electricity transfer capacity, but is only effective in decreasing the saturation flux density.

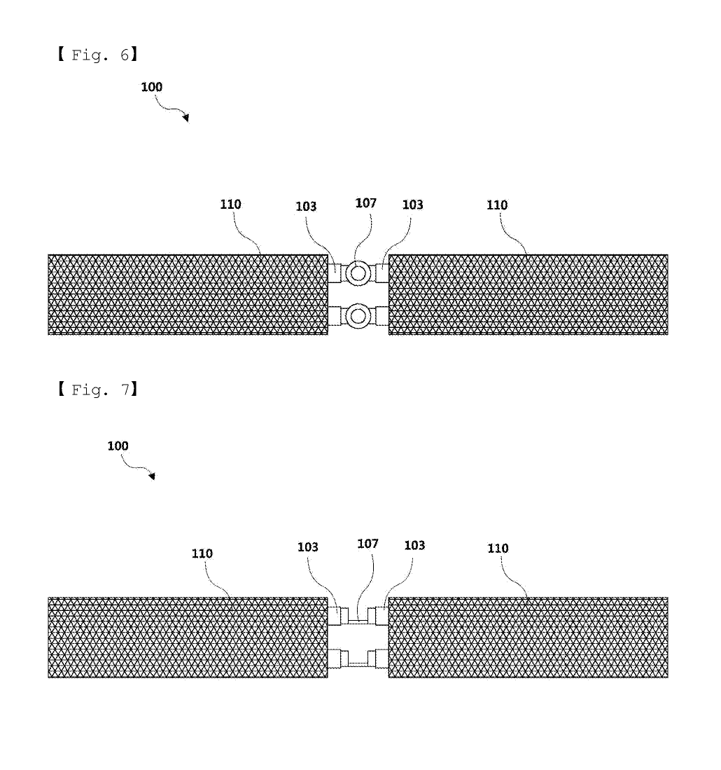

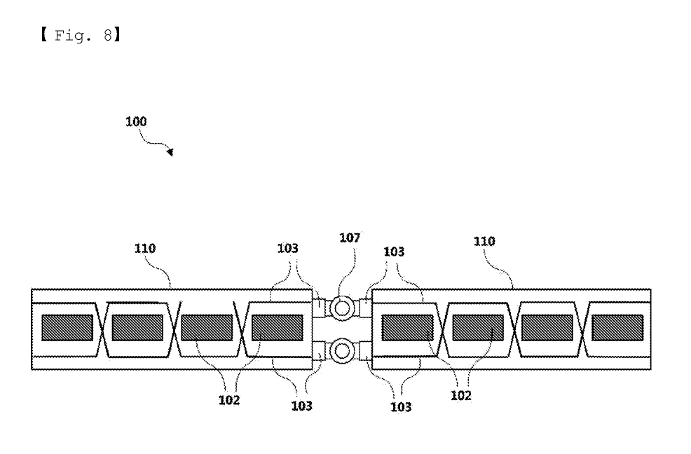

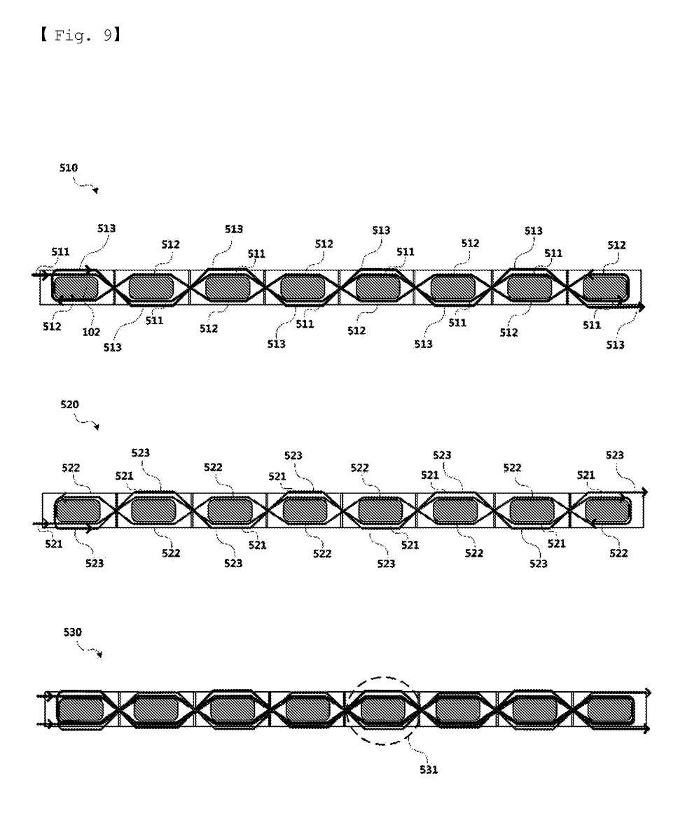

While FIG. 2 illustrates an example in which two electricity supply wires 103 are wound around the respective core magnetic poles 102 only once, a method is suggested according to the present invention to wind the electricity supply wires 103 at least two times, which will be explained below in greater detail with reference to FIGS. 7 and 8.

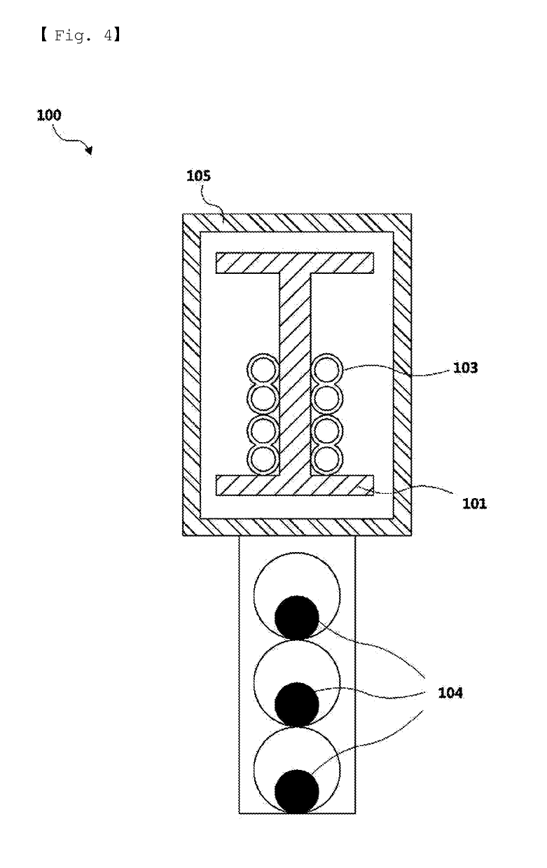

FIG. 3 is a side view of an electricity supply rail at which an electric-vehicle electricity supply device 100 is installed, in which an electric-vehicle electricity supply wire is wound around an I shape electricity supply core in a zigzag pattern. FIG. 3 is a side view of a modular I shape electricity supply rail according to an embodiment, in which eight electricity supply cores (i.e., magnetic poles 102) are modularized as one module. For higher output, the number of electricity supply cores may be increased. Additionally, the number of winding the electricity supply wires 103 may be adjusted by adopting mono- or dual-cable, depending on how much electric current is necessary.

FIG. 4 is a front view of the electricity supply rail of FIG. 2 at which an electric-vehicle electricity supply device 100 having a common line 104 is installed, in a structure in which an electric-vehicle electricity supply wire is wound around an I shape electricity supply core in a zigzag pattern.

Referring to FIG. 4, after the I shape electricity supply core 101 is installed, and the electricity supply wire 103 is wound around the electricity supply core in a zigzag pattern, it is inserted into the fiber reinforced plastic (FRP) tube 105. The common line and signal line cables 104 may be inserted under the electricity supply rail module into the FRP tube, and it is possible to additionally insert it by digging the road depending on need. It is particularly possible to ON/OFF control the respective segments of the modularized electricity supply device (i.e., electricity supply core module) individually through the common line 104, to thereby reduce unnecessary electricity use and EMF influence.

FIG. 5 is a front view of covers 106 on both ends of an electricity supply rail module. A hole is bored to allow the electricity supply wire 103 to pass therethrough for inter-module coupling, followed by cable coupling and then waterproofing to prevent moist from entering the FRP tube.

FIG. 6 is a front view illustrating a coupling state between the electricity supply core modules 110 of an electric-vehicle I shape electricity supply device 100. The respective electricity supply wires are connected with electricity supply coupling portions (i.e., connectors) 107 and the connectors are coupled with each other. Accordingly, it is possible to move the coupled portion in lateral or vertical direction by adjusting the angle of coupling between the electricity supply core modules 110 appropriately depending on the road condition. Accordingly, the plurality of electricity supply core modules 110 connected to each other may be faced straightforward, or bent in lateral or vertical direction. Referring to FIG. 4 and as explained above, it is possible to individually ON/OFF control the respective modularized electricity supply device segments (i.e., electricity core modules) 110 through the common line 104, thereby reducing unnecessary electricity use and EMF influence.

FIG. 7 is a side view illustrating a coupling state between the electricity supply core modules 110 of an electric-vehicle I shape electricity supply device.

FIG. 8 is a plan view illustrating a coupling state between the electricity supply core modules 110 of an electric-vehicle I shape electricity supply device 100 and interior thereof. As shown, the electric-vehicle electricity supply wire 103 is wound around the magnetic pole 102 in zigzag pattern, each electricity supply wire 103 is connected with the electricity supply wire coupling portion (i.e., connector) 107, and the respective connectors are connected to each other using bolts. It is possible to individually ON/OFF control the respective modularized electricity supply device segments (i.e., electricity core modules) 110 through the common line 104 (see FIG. 4), thereby reducing unnecessary electricity use and EMF influence.

FIG. 9 is a view illustrating an electricity supply module structure in which electricity supply wire is wound three times according to an embodiment. FIG. 9 illustrates an example of an electricity supply module having eight electricity supply core magnetic poles 102.

For inter-module coupling, the electricity supply wire entering the left side has to exit to the right side. Accordingly, as shown in the drawing 510 of a first electricity supply wire arrangement, the cable entering the left upper side is wound one and a half time and then exits to the right lower side. That is, the first electricity supply wire 511 entering the left upper side is continued in zigzag pattern to rightward direction (511), wound around the right side of the right-most magnetic pole and continued in zigzag pattern to leftward direction (512), again wound around the left side of the left-most magnetic pole and continued in zigzag pattern to rightward direction (513), and then exit to the right side of the electricity supply module to be connected to the electricity supply module at the right side.

Next, as shown in a drawing of a second electricity supply wire arrangement 520, the cable entering the left lower side is wound one and a half time and exit to the right upper side. That is, the second electricity supply wire 521 entering the left lower side is continued in zigzag pattern to rightward direction (521), wound around the right side of the right-most magnetic pole and continued in zigzag pattern to leftward direction (522), again wound around the left side of the left-most magnetic pole and continued in zigzag pattern to rightward direction (523), and then exit to the right side of the electricity supply module to be connected to the electricity supply module at the right side.

In a drawing 530 illustrating the state where both the first and second electricity supply modules are arranged on the electricity supply module, the electricity supply wire arrangements 510, 520 are overlain on each other. As a result, the electricity supply core magnetic poles have a pattern 531 in which the electricity supply wires are wound three times.

As shown in the drawing, the first and second electricity supply wires are arranged so that the wires go from left end to the right end, go back to the left end and then exit to the right end. If the electricity supply wires are arranged in the above-mentioned manner to reciprocate two times and exit to the right end, the electricity supply wire is wound around the electricity supply core magnetic pole five times. If the electricity supply wires are arranged in the above-mentioned manner to reciprocate three times and exit to the right end, the electricity supply wire is wound around the electricity supply core magnetic pole seven times. In other words, the electricity supply wire is wound around each electricity supply core magnetic pole by an odd number of times such as 3, 5, 7, and so on. Higher magnetic field output is obtained as the number of winding increases.

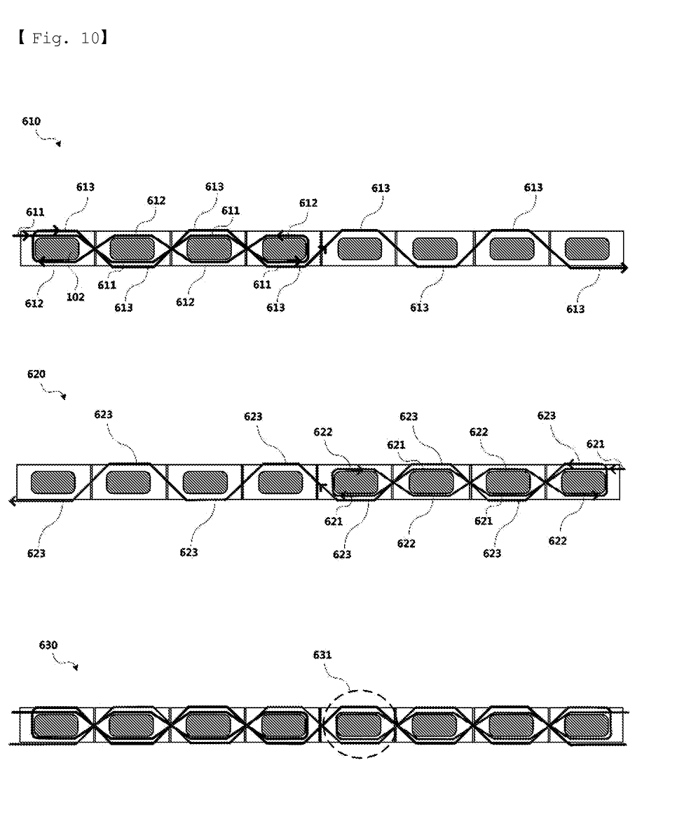

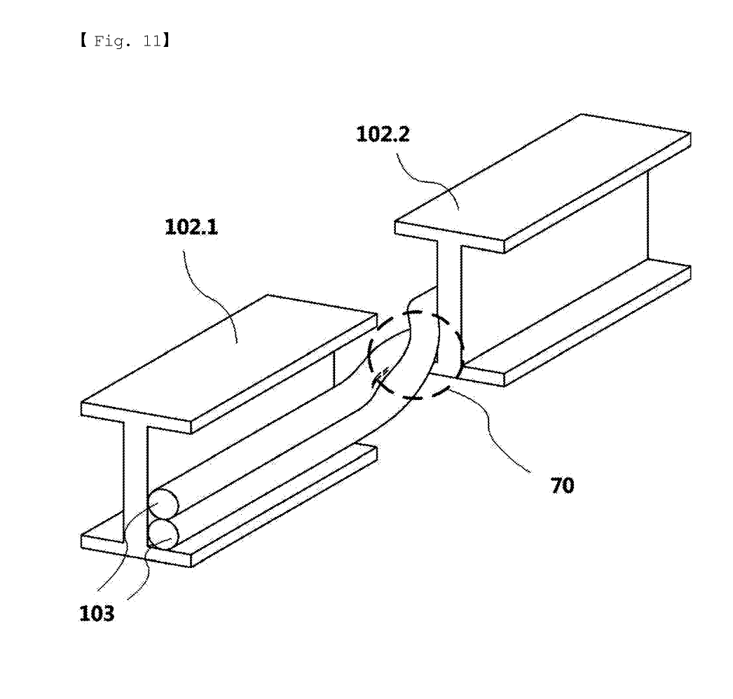

FIG. 10 is a view illustrating an electricity supply module structure in which electricity supply wire is wound two times according to an embodiment. FIG. 10 illustrates an example of an electricity supply module having eight electricity supply core magnetic poles 102.

For inter-module coupling, the electricity supply wire entering the left side has to exit to the right side.

Accordingly, as shown in the drawing 610 of a first electricity supply wire arrangement, the cable entering the left upper side is wound one and a half time and then exits to the right lower side. But there is the following difference from the example of FIG. 9. That is, the first electricity supply wire 611 entering the left upper side is continued in zigzag pattern to rightward direction (611), wound around the right side of the fourth magnetic pole (out of the eight magnetic poles) from the left side and continued in zigzag pattern to leftward direction (612), again wound around the left side of the left-most magnetic pole and continued in zigzag pattern to rightward direction (613), and then exit to the right side of the electricity supply module to be connected to the electricity supply module at the right side.

Next, as shown in a drawing of a second electricity supply wire arrangement 620, the cable entering the right upper side is wound one and a half time and exits to the left lower side. That is, the second electricity supply wire 621 entering the right upper side is continued in zigzag pattern to leftward direction (621), wound around the left side of the fourth magnetic pole (out of the eight magnetic pole) from the right side and continued in zigzag pattern to rightward direction (622), again wound around the right side of the right-most magnetic pole and continued in zigzag pattern to leftward direction (623), and then exits to the left side of the electricity supply module to be connected to the electricity supply module at the left side.

In a drawing 630 illustrating the state where both the first and second electricity supply modules are arranged on the electricity supply module, the electricity supply wire arrangements 610, 620 are overlain on each other. As a result, the electricity supply core magnetic poles have a pattern 631 in which the electricity supply wires are wound three times.

As shown in the drawing, the first electricity supply wire (and also the second electricity supply wire) is arranged so that the wire goes from left end to the fourth magnetic pole from the left side, turns around at the right side of the fourth magnetic pole from the left side to go back to the left end and then exits to the right end. However, if the electricity supply wire is arranged to reciprocate three times and exit to the right end, the electricity supply wire is wound around the electricity supply core magnetic pole four times. If the electricity supply wire is arranged to reciprocate five times and exit to the right end, the electricity supply wire is wound around the electricity supply core magnetic pole six times. In other words, the electricity supply wire is wound around each electricity supply core magnetic pole by an even number of times such as 2, 4, 6, and so on. Higher magnetic field output is obtained as the number of winding increases.

FIG. 11 is a view illustrating a method for winding an electricity supply wire using dual cable.

In order for the electricity supply wire 103 on the right side of the I shape electricity supply core magnetic pole 102.1 to enter the left side of the next I shape electricity supply core magnetic pole 102.2, the two electricity supply wires 103 have to cross each other in vertical direction instead of being parallel to each other (70). This is because if the electricity supply wires are in parallel to each other, the electricity supply wire (not illustrated) at the left side of the electricity supply core magnetic pole 102.1 can be overlain on the electricity supply wire 103 to increase height by two times as the same enters the right side of the next electricity supply core magnetic pole 102.2 in zigzag pattern. Therefore, the cable is wound to closest contact with the core at the electricity supply core magnetic poles 102.1, 102.2, and wound to cross each other in vertical direction as shown in FIG. 11 to reduce the height of the dual cable between the cores. This may apply to both the example where the cable is wound by an even number of times and an odd number of times.

### INDUSTRIAL APPLICABILITY

The present invention can be effectively applied in an on line electric vehicle (OLEV) system which directly supplies electricity to an electric vehicle in motion through an electricity supply device buried under the road.

1. A modular electric-vehicle electricity supply device for supplying electricity to an electric vehicle in an inductive coupling manner, comprising:
an electricity supply core comprising a plurality of electricity supply core modules connected to each other along a direction of travel on a road, the electricity supply core modules each comprising one or more magnetic poles and an electricity supply wire coupling portion on both front and rear ends;
an electricity supply wire arranged so that magnetic poles of the electricity supply core neighboring each other have different polarities along the direction of travel; and
a common line to individually control the electricity supply core modules to be either ON or OFF.

2. The modular electric-vehicle electricity supply device of claim 1, wherein the electricity supply wire is arranged such that the electricity supply wire is wound around each magnetic pole by at least two times.

3. The modular electric-vehicle electricity supply device of claim 1, wherein a width of the electricity supply core at right angles to the direction of travel on the road is at most a half of a magnetic pole gap which is a distance between centers of the magnetic poles.

4. The modular electric-vehicle electricity supply device of claim 1, wherein the respective electricity supply core modules are connected to each other as the electricity supply wires protruding from both ends of each of the electricity supply core modules is connected to each other and are coupled by the electricity supply wire coupling portion.

5. The modular electric-vehicle electricity supply device of claim 1, wherein a length of the magnetic pole in the direction of travel on the road is at least two times greater than a distance between adjacent ends of the magnetic poles which neighbor each other.

6. The modular electric-vehicle electricity supply device of claim 1, wherein the electricity supply core is constructed so that the electricity supply core is faced straightforward or bent in a lateral or vertical direction according to adjustment of a coupling angle between the respective electricity supply core modules.

7. The modular electric-vehicle electricity supply device of claim 1, wherein the electricity supply core and the electricity supply wire are received inside a fiber reinforced plastic (FRP) tube to be protected from road environment.

8. The modular electric-vehicle electricity supply device of claim 1, wherein the respective electricity supply core modules are controlled to be in an ON electricity supply state using the common line only when the electric vehicle passes thereabove.

9. An electricity supply wire arrangement method for winding electricity supply wires around respective electricity supply core magnetic poles of electricity supply modules of a modular electricity supply device which supplies electricity to an electric vehicle in an inductive coupling manner, the electricity supply wire arrangement method winding the electricity supply wires around the respective electricity supply core magnetic poles by an odd number of times, comprising:
(a) arranging an electricity supply wire (‘first electricity supply wire’) from a left upper side of the electricity supply module to the right side in zigzag pattern between the respective electricity supply core magnetic poles;
(b) winding the first electricity supply wire around a right side of a right-most magnetic pole of the electricity supply module, and extending the first electricity supply wire to the left side of the electricity supply module, in zigzag pattern in which the first electricity supply wire crosses the electricity supply wire arranged at step (a) between the respective electricity supply core magnetic poles;
(c) winding the first electricity supply wire on a left side of a left-most magnetic pole of the electricity supply module, arranging the first electricity supply wire in zigzag pattern to the right side of the electricity supply module and arranging so that the first electricity supply wire exits to the right side of the electricity supply module; and
(d) arranging another electricity supply wire (‘second electricity supply wire’) other than the first electricity supply wire in the same manners as in steps (a) to (c) between left lower side and the right side.

10. The electricity supply wire arrangement method of claim 9, further comprising, between the steps (b) and (c), (b1) repeating the steps (a) to (b) by an integer number of times.

11. An electricity supply wire arrangement method for winding electricity supply wires around respective electricity supply core magnetic poles of electricity supply modules of a modular electricity supply device which supplies electricity to an electric vehicle in an inductive coupling manner, the electricity supply wire arrangement method winding the electricity supply wires around the respective electricity supply core magnetic poles by an even number of times, comprising:
(a) arranging an electricity supply wire (‘first electricity supply wire’) from a left upper side of the electricity supply module to a right side of a (n/2)th magnetic pole (‘intermediate magnetic pole’) out of (n) number of magnetic poles, in zigzag pattern between the respective electricity supply core magnetic poles;
(b) winding the first electricity supply wire around a right side of the intermediate magnetic pole of the electricity supply module, and extending the intermediate electricity supply wire to the left side of the electricity supply module, in zigzag pattern in which the first electricity supply wire crosses the electricity supply wire arranged at step (a) between the respective electricity supply core magnetic poles;
(c) winding the first electricity supply wire on a left side of a left-most magnetic pole of the electricity supply module, arranging the first electricity supply wire in zigzag pattern to the right side of the electricity supply module and arranging so that the first electricity supply wire exits to the right side of the electricity supply module; and
(d) arranging another electricity supply wire (‘second electricity supply wire’) other than the first electricity supply wire in the same manners as in steps (a) to (c) between right upper side and the left side.

12. The electricity supply wire arrangement method of claim 11, further comprising, between the steps (b) and (c), (b1) repeating the steps (a) to (b) by an even number of times.

13. The electricity supply wire arrangement method of claim 11, two or more electricity supply wires arranged in zigzag pattern between the respective electricity supply core magnetic poles are arranged to cross each other in vertical direction.
